(19) United States
(12) Patent Application Publication
(10) Pub. No.: US 2006/0159321 A1
(43) Pub. Date: Jul. 20, 2006

(54) Breast image display apparatus and program therefor

(75) Inventors: Hideya Takeo, Kanagawa-ken (JP); Chou Shi, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/212,613

(22) Filed: Aug. 29, 2005

(30) Foreign Application Priority Data
Aug. 27, 2004 (JP) 248366/2004

(51) Int. Cl. G06K 9/00

(52) U.S. Cl. 382/128

(57) ABSTRACT

A breast image display apparatus is provided for improving image reading performance on breast images. A right breast area and a left breast area are detected from a right breast image and a left breast image. A plurality of corresponding position detection means are available for detecting pre-set corresponding positions in the right breast area and the left breast area. In the case where one of the corresponding position detection means has failed to detect the corresponding positions therefor, another one of the corresponding position detection means detects the corresponding positions therefor in the right breast area and the left breast area.

### BACKGROUND OF THE INVENTION

1. Field of the Invention

The present invention relates to a breast image display apparatus. More specifically, the present invention relates to improvement in an apparatus and a program for displaying two breast images for comparison.

2. Description of the Relates Art

There has been developed a system (an abnormality candidate detection system) wherein a digital image signal obtained by radiography of a breast or the like is analyzed by a computer and an abnormality such as a pattern of tumor or microcalcification is automatically detected for supporting diagnosis (see Japanese Unexamined Patent Publication No. 8(1996)-294479, for example). By using the system, an ability of detection can be maintained at a certain level even in the case where an image reader is not sufficiently skilled.

In such a system, an algorithm is used for detecting candidates of abnormalities such as tumors, microcalcifications or the like. In the algorithm, evaluation is carried out on concentration of gradient vectors of density (that is, signal values) in a digital image signal representing a radiograph (mammogram) of a breast obtained mainly by breast cancer screening, and a candidate of a tumor in the image is automatically detected based on the results of the evaluation. Furthermore, in the algorithm, the digital image signal is subjected to morphology processing (such as dilation, erosion, opening and closing processing) for automatically detecting a candidate of microcalcification. The candidate detected by the system is, for example, marked with a rectangular frame to indicate a ROI (Region Of Interest) in the mammogram, and displayed on a CRT or LCD display device or printed on film to be provided for diagnosis.

In the case where the mammogram having the abnormality candidate detected by the abnormality candidate detection system is displayed on a screen of the image display device for a physician or the like to carry out image reading, a mammogram representing the other breast of the same patient is often displayed together in a symmetrical manner. Since normal structures are almost the same in right and left breasts, the structures can be compared for diagnosis. For example, in the case where a suspicious pattern has been detected in one of the images, abnormality is judged based on whether a similar pattern is observed at a corresponding position in the other image. Furthermore, since an ML view (MedioLateral view) or an MLO view (MedioLateral Oblique view) and a CC view (CranioCaudal view) can be obtained by radiography of a breast from the medial side outward and from above, image reading is sometimes carried out by comparison of the two types of images representing the breast of either (right or left) side.

However, in the case where two images to be compared are displayed together in a symmetrical manner, the subject in the images may be displayed without position alignment in either the vertical or the horizontal direction, which causes image reading to be difficult. Therefore, an image display method has been proposed wherein two mammograms to be compared are displayed on a display screen such that nipples of both breasts are vertically aligned (see Japanese Unexamined Patent Publication No. 2002-065613, for example).

However, in the case where a nipple has been lost due to breast cancer or the like, the method in Japanese Unexamined Patent Publication No. 2002-065613 is not applicable. Furthermore, the structures in right and left breasts do not necessarily appear in symmetry by alignment of nipples.

### SUMMARY OF THE INVENTION

The present invention has been conceived based on consideration of the above circumstances. An object of the present invention is therefore to provide a breast image display apparatus and a program for improving image reading performance regarding two breast images displayed for comparison.

A breast image display apparatus of the present invention is a breast image display apparatus for displaying a right breast image and a left breast image in alignment with respect to each other, and the image display apparatus comprises:

breast area detection means for detecting a right breast area representing a right breast and a left breast area representing a left breast in the right breast image and the left breast image;

a plurality of corresponding position detection means for respectively detecting different preset corresponding positions in the right breast area and the left breast area that have been detected; and

alignment means for causing one of the corresponding position detection means to detect the corresponding positions therefor in the right breast area and in the left breast area and for carrying out the alignment between the right breast image and the left breast image based on the detected positions in the case where the corresponding positions have been detected, or else for causing another one of the corresponding position detection means to detect the corresponding positions therefor and for carrying out the alignment between the images based on the detected positions.

A program of the present invention causes a computer in a breast image display apparatus for displaying a right breast image and a left breast image in alignment with respect to each other to function as:

breast area detection means for detecting a right breast area representing a right breast and a left breast area representing a left breast in the right breast image and the left breast image;

a plurality of corresponding position detection means for respectively detecting different preset corresponding positions in the right breast area and the left breast area; and

alignment means for causing one of the corresponding position detection means to detect the corresponding positions therefor in the right breast area and in the left breast area and for carrying out the alignment between the right breast image and the left breast image based on the detected positions in the case where the corresponding positions have been detected, or else for causing another one of the corresponding position detection means to detect the corresponding positions therefor and for carrying out the alignment between the images based on the detected positions.

The breast image display apparatus refers to not only a display device such as a CRT display device but also an apparatus for recording the images in a medium such as film in a visible manner.

The breast areas refer to areas including pectoralis muscles and the like in the case where the muscles and the like are included in the breast images due to the direction of radiography.

The plurality of corresponding position detection means may include at least two of:

nipple position detection means for detecting positions of nipples as the corresponding positions in the right breast area and in the left breast area;

highest-point position detection means for detecting highest points as the corresponding positions in the right breast area and in the left breast area;

nipple and highest point detection means for detecting a position of a nipple in either the right breast area or the left breast area and a highest point in the other breast area, as the corresponding positions;

mammary-gland map centroid detection means for detecting centroids of mammary gland maps as the corresponding positions in the right breast area and in the left breast area;

outline position detection means for detecting outlines of the right breast area and the left breast area whose positions are used as the corresponding positions; and

pectoralis muscle line position detection means for detecting pectoralis muscle lines whose positions are used as the corresponding positions in the right breast area and the left breast area.

According to the present invention, in order to display the right breast image and the left breast image in alignment with respect to each other, the corresponding positions in the right breast area and the left breast area can be detected by the plurality of corresponding position detection means whose targets of detection (corresponding positions) are different. In the case where one of the corresponding position detection means cannot be used for the alignment, another one of the corresponding position detection means can be used for the alignment. Therefore, accurate alignment can be realized, leading to less failure in alignment.

### BRIEF DESCRIPTION OF THE DRAWINGS

FIG. 1 shows the schematic configuration of a breast image display apparatus of the present invention;

FIG. 2 shows histograms of pixel values in mammograms;

FIG. 3 shows a result of binarization of the mammograms;

FIG. 4 shows the configuration of nipple position detection means;

FIG. 5 explains a method of detecting a skin line;

FIG. 6 explains detection of a nipple protrusion from the skin line;

FIGS. 7A and 7B are diagrams for explaining detection of the nipple protrusion by top-hat transform;

FIGS. 8A and 8B are diagrams for explaining detection of the nipple protrusion by a quadratic differential;

FIG. 9 shows the configuration of highest-point position detection means;

FIG. 10 shows the configuration of nipple and highest point detection means;

FIG. 11 shows the configuration of outline position detection means;

FIG. 12 shows the configuration of pectoralis muscle line position detection means;

FIG. 13 shows a mammogram taken from the side;

FIG. 14 is a diagram for explaining a method of extracting boundary points in an edge image;

FIG. 15 shows a pectoralis muscle line extracted in the case where the number of the extracted boundary points is 1;

FIG. 16 shows the configuration of mammary-gland map centroid detection means;

FIG. 17 shows mammary gland maps in right and left breasts;

FIG. 18 shows histograms representing pixel values used as reference values for detecting mammary glands;

FIG. 19 is a flow chart showing a procedure carried out by alignment means;

FIG. 20 is a diagram for explaining alignment between a nipple and a highest point;

FIG. 21 is a diagram for explaining alignment by pectoralis muscle lines;

FIGS. 22A through 22D explain alignment by skin lines;

FIG. 23 is a diagram for explaining alignment by centroids in mammary gland maps;

FIG. 24 is a diagram for explaining a method of selecting an alignment method before alignment; and

FIG. 25 shows an example of alignment by highest points in an MLO direction.

### DESCRIPTION OF THE PREFERRED EMBODIMENT

Hereinafter, an embodiment of a breast image display apparatus of the present invention will be described with reference to the accompanying drawings.

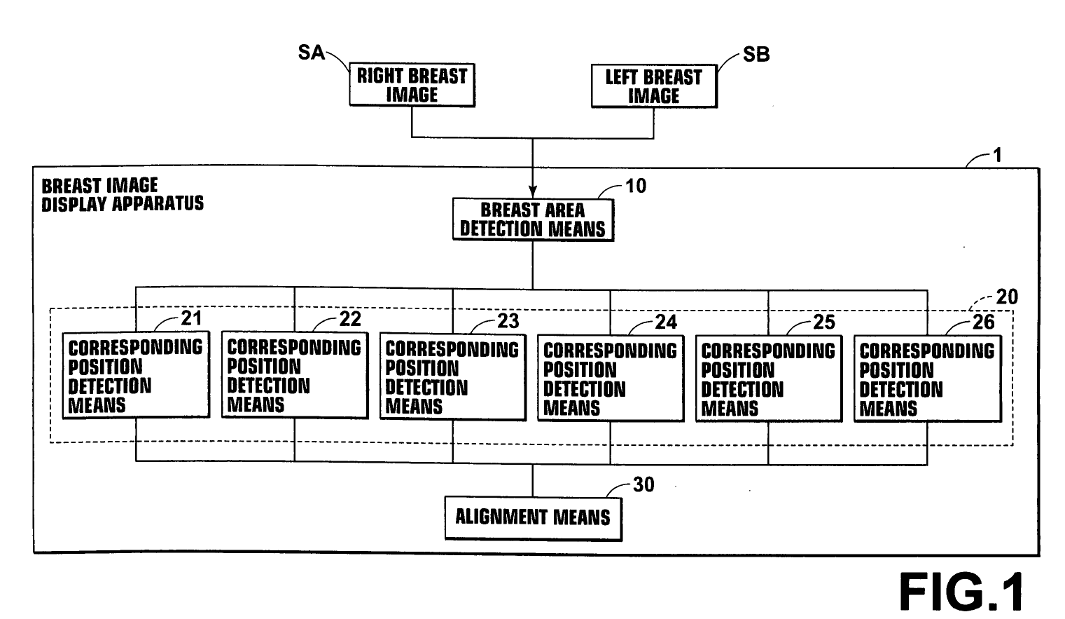

As shown in FIG. 1, a breast image display apparatus 1 comprises breast area detection means 10, a plurality of corresponding position detection means 20, and alignment means 30. The breast area detection means 10 detects a right breast area and a left breast area from a right breast image SA and a left breast image SB. The corresponding position detection means 20 respectively detect corresponding positions therefor in the right breast area and the left breast area. The alignment means 30 causes one of the corresponding position detection means 20 to detect the corresponding positions therefor in the right breast area and the left breast area. In the case where the corresponding position detection means has failed to detect the corresponding positions, the alignment means 30 causes another one of the corresponding position detection means 20 to detect the corresponding positions therefor in the right breast area and the left breast area. The alignment means 30 then carries out alignment between the right breast image SA and the left breast image SB.

The right breast image SA and the left breast image SB are generally displayed in a symmetric manner for easier observation thereof. In order to automatically display the images in this manner, the corresponding positions in the right and left breasts need to be detected and aligned. Especially, the images are preferably displayed in such a manner that distributions of mammary glands relative to positions of nipples are symmetric. However, in the case where the nipple or nipples have been lost due to a disease such as cancer, nipple detection is impossible. Therefore, the alignment needs to be carried out through detection of the corresponding positions other than nipples.

For this reason, the breast image display apparatus 1 has the plurality of corresponding position detection means 20 so that the alignment means 30 can cause any one of the corresponding position detection means 20 to detect the corresponding positions therefor even in the case where another one of the corresponding position detection means 20 has failed to detect the positions therefor.

More specifically, the corresponding position detection means 20 comprise nipple position detection means 21, highest-point position detection means 22, nipple and highest point detection means 23, mammary-gland map centroid detection means 24, outline position detection means 25, and pectoralis muscle line position detection means 26. The nipple position detection means 21 detects positions of nipples in the right breast area and the left breast area as the corresponding positions therefor. The highest-point position detection means 22 detects positions of highest points in the right breast area and in the left breast area as the corresponding positions therefor. The nipple and highest point detection means 23 detects a position of nipple in either one of the breast areas and detects a highest point in the other breast area. The nipple and highest point detection means 23 uses the positions of the nipple and the highest point as the corresponding positions therefor in the right breast area and the left breast area. The mammary-gland map centroid detection means 24 detects positions of centroids of mammary gland maps in the right breast area and the left breast area as the corresponding positions therefor. The outline position detection means 25 detects outlines (hereinafter referred to as skin lines) of the right breast area and the left breast area, and uses positions of the skin lines as the corresponding positions therefor. The pectoralis muscle line position detection means 26 detects pectoralis muscle lines in the right breast area and the left breast area, and uses positions thereof as the corresponding positions therefor in the right breast area and the left breast area.

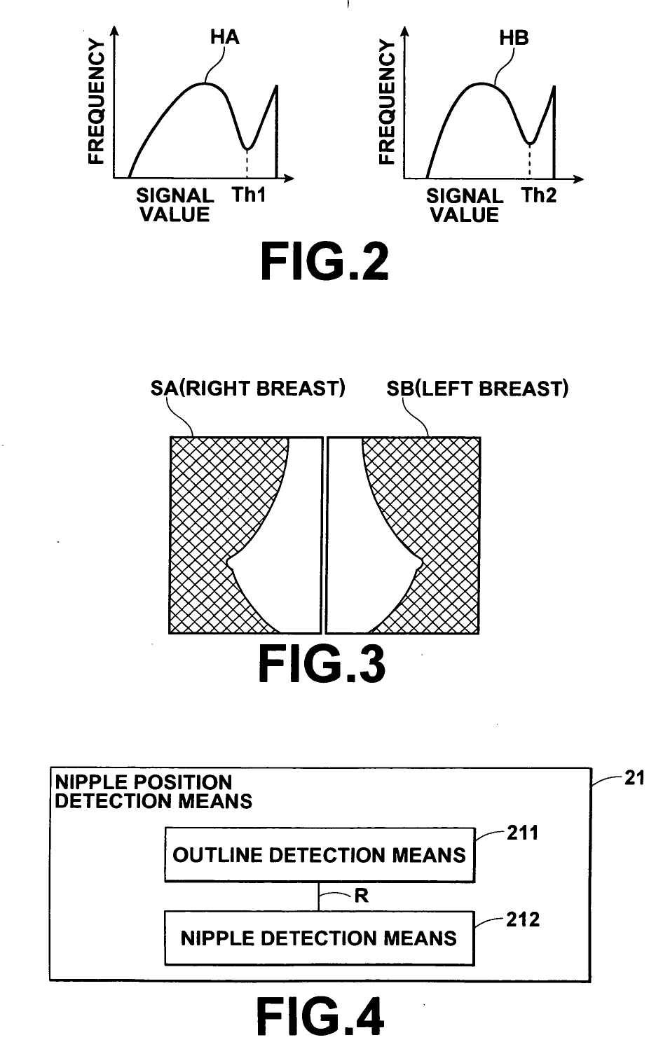

The breast area detection means 10 detects the right breast area based on a histogram of the right breast image SA. As shown in FIG. 2, a histogram HA generated from the right breast image SA has two peaks of pixel values. One of the peaks appearing near the center is a peak for the breast area and the other peak appearing in the right is a peak for a background area. Therefore, binarization processing is carried out by using a threshold value Th1 representing a boundary signal between the breast area and the background area, and the right breast image SA is divided into the breast area and the background area (a cross-hatched area) as shown in FIG. 3. Likewise, the left breast area is detected by binarization processing using a threshold value Th2 representing a boundary signal between the breast area and the background area in a histogram HB of the left breast image SB.

The nipple position detection means 21 comprises outline detection means 211 for detecting an outline (the skin line) R of each of the breasts and nipple detection means 212 for detecting a protrusion of the outline as the nipple from the corresponding breast area, as shown in FIG. 4.

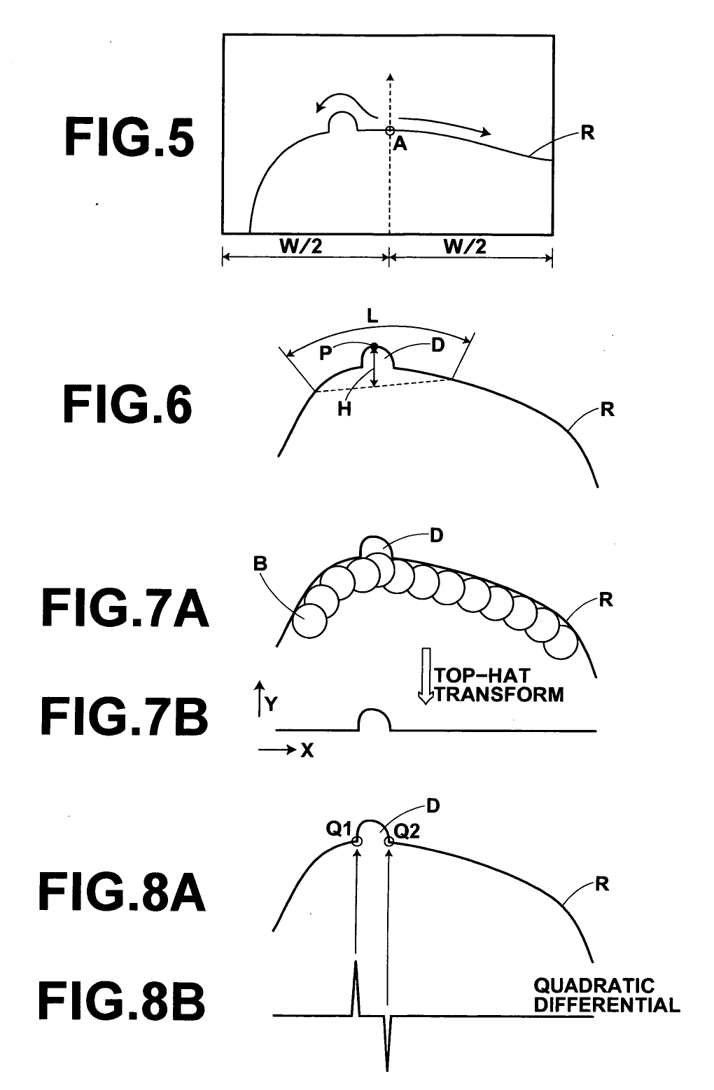

As shown in FIG. 5, In the case where the chest wall of the image binarized by the breast area detection means 10 is located on the bottom side of the image, the outline detection means 211 searches for a point A whereat the breast area changes to the background area, from the bottom to the top of the binarized image along a broken line passing through the middle (W/2) of a width W of the image. The outline detection means 211 then detects the skin line R by a search therefor to the right and left directions from the point A. More specifically, the outline detection means 211 sequentially searches pixels arranged in the right and left directions starting from the point A for pixels at a boundary between the breast area and the background area in the binarized image, and connects the pixels found in this manner to form the skin line R.

The nipple detection means 212 sets a curve whose length is L along the skin line R as shown in FIG. 6, and finds a distance H from a middle point P located at the center of the length L of the curve to a line connecting both ends of the curve. The nipple detection means 212 sets the same curves of the same length L at intervals, and finds the distance H from the middle point P of each of the curves to the corresponding line. The nipple detection means 212 then detects the nipple, assuming that a nipple protrusion D is located near the center point P of the curve whose H/L value is the largest. A length of the intervals of the curves is set based on a statistical size of nipples in such a manner that the middle point P is located on the nipple protrusion D in the skin line R for at least one time.

Alternatively, as shown in FIG. 7A, top-hat transform may be carried out on the skin line R detected by the outline detection means 211, by using a circular element that is generated based on the statistical size of nipples so as not to enter an area corresponding to the nipple protrusion. A curve having varying Y coordinate values only around the position of the nipple is then obtained as shown in FIG. 7B as a result of the transform, and the part having the varying Y coordinate values is detected as the nipple protrusion D.

Alternatively, values of a quadratic differential may be found from the skin line R detected by the outline detection means 211. In this case, as shown in FIG. 8B, the values are almost the same for a part other then the nipple but change sharply at positions Q1 and Q2 shown in FIG. 8A representing boundaries of the nipple. The positions Q1 and Q2 at which the values change are detected as a starting point and an ending point of the nipple, whereby the nipple protrusion D is detected according to the points.

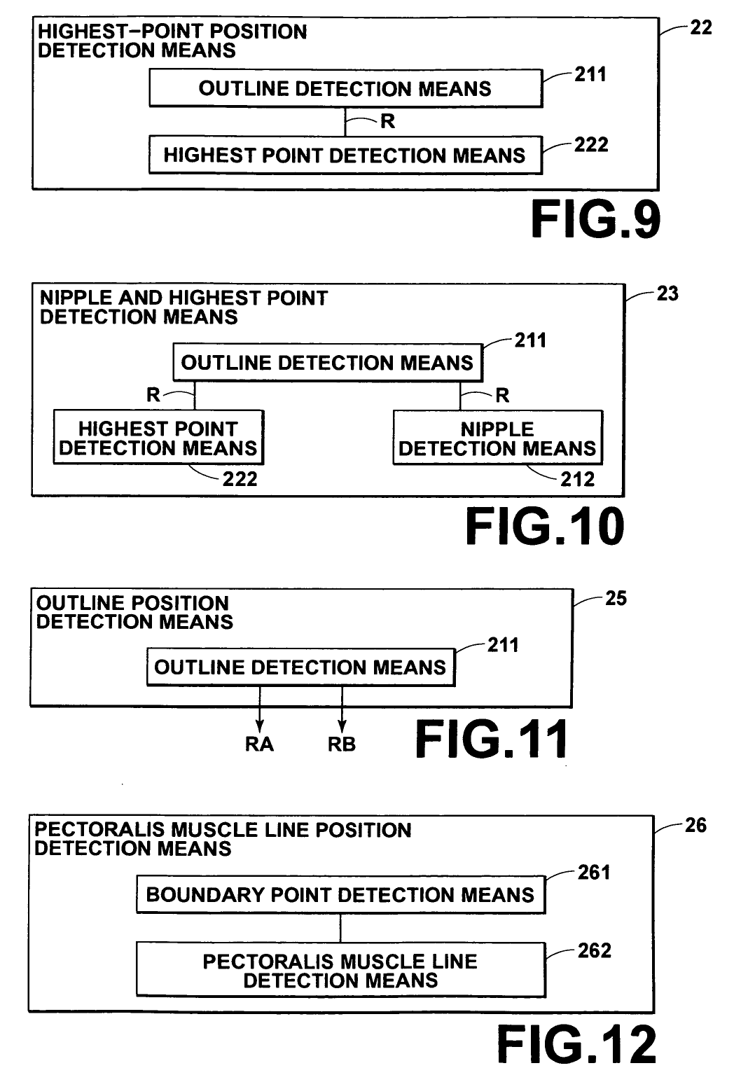

The highest-point position detection means 22 comprises the outline detection means 211 and highest point detection means 222 for detecting the highest points in the skin line R, as shown in FIG. 9.

The skin line R is detected as shown in FIG. 5 by the outline detection means 211 described above, and the highest point detection means 222 detects the point having the largest Y coordinate value in the skin line R of the breast area of each of the breast images as the highest point, and uses the highest points as the corresponding positions.

The nipple and highest point detection means 23 comprises the outline detection means 211, the nipple detection means 212, and the highest point detection means 222, as shown in FIG. 10.

The nipple detection means 212 carries out the nipple detection in the right breast image SA and in the left breast image SB. In the case where the nipple has not been detected in either one of the breast images, the highest point detection means 222 detects the highest point in the image from which the nipple has not been found. The nipple and the highest point are then used as the corresponding positions.

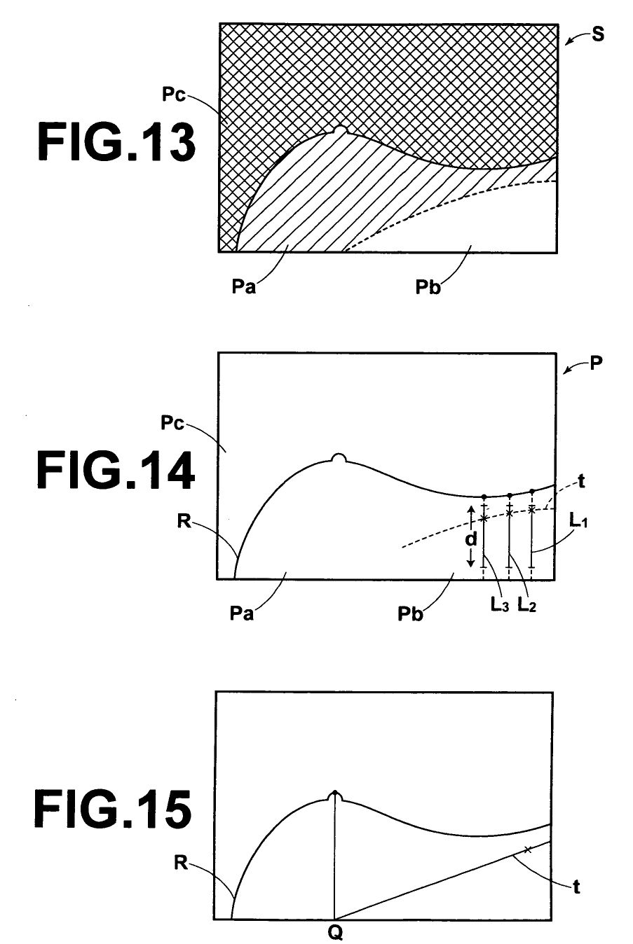

The outline position detection means 25 comprises the outline detection means 211, as shown in FIG. 11. The outline position detection means 25 divides each of the breast images into the breast area including a pectoralis muscle area (referred to as Pa and Pb in FIG. 13) and the background area (referred to as Pc), based on the corresponding histogram. The outline position detection means 25 then detects the skin lines R of the right breast image SA and the left breast image SB.

AS shown in FIG. 12, the pectoralis muscle line position detection means 26 comprises boundary point detection means 261 for detecting boundary points on a boundary line between the breast area and the pectoralis muscle area according to each of the breast images, and pectoralis muscle line detection means 262 for detecting a pectoralis muscle line according to the number of the boundary points detected by the boundary point detection means 261.

In the case where the breast images are MLO images, the pectoralis muscles often appear together with the breasts. FIG. 13 shows the right breast image SA radiographed in the MLO direction. For the left breast, right and left are reversed. Hereinafter, the example of the right breast image SA will be described.

The right breast image SA has the breast area Pa excluding the pectoralis muscle area, the pectoralis muscle area Pb, and the background area Pc. The pectoralis muscle area Pb is shown as an area of lower density than the breast area Pa, and the boundary between the pectoralis muscle area Pb and the breast area Pa is the pectoralis muscle line. The pectoralis muscle line appears as a line from the right toward lower left of the right breast image SA.

AS has been described above for the breast area detection means 10, the boundary point detection means 261 separates the background area Pc from the breast area Pa and the pectoralis muscle area Pb, based on the histogram HA (and HB for the case of the left breast) of the image SA (and SB).

Since the density of the pectoralis muscle area Pb tends to be lower than that of the breast area Pa and density gradients at the boundary tend to be higher than a surrounding area, the boundary point detection means 261 generates an edge image P by using density gradient vectors. In the edge image P, the boundary line between the pectoralis muscle area Pb and the breast area Pa is shown as a pattern of low density (that is, a white pattern).

A method of detection of the boundary points will be described next, with reference to a pattern diagram of the edge image P shown in FIG. 14. In the actual edge image P, each of the edges (such as a pectoralis muscle line t between the breast area Pa and the pectoralis muscle area Pb, and the skin line R between the breast area Pa and the background area Pc) is represented by a pattern of low density (that is, a white pattern). However, in the diagram shown in FIG. 14, these patterns are shown by black lines for the sake of convenience in description. Hereinafter, in the case where the areas such as the breast area Pa and the pectoralis muscle area Pb and the lines such as the pectoralis muscle line t and the skin line R need to be distinguished between the right breast image SA and the left breast image SB, “A” and “B” are added to the reference codes thereof. Otherwise, “A” and “B” are not added.

Firstly, 3 vertical scanning lines L₁ to L₃ are set in an area in the right (an area corresponding to the upper breast), within an area representing the subject in the edge image P. For example, in the case where the breast image is a 10-bit image and has 10 pixels/mm, the first scanning line L₁ in the rightmost position is set at a position separated from the right end of the image by 200 pixels. The second line L₂ and the third line L₃ are respectively set at 300-pixel intervals from the line L₁.

Directivity edge search is carried out within a 20˜80% range d of the scanning lines in the area representing the subject shown in FIG. 14, based on the breast area Pa and the pectoralis muscle area Pb. The directivity edge search refers to a search for an edge of descending density in the case where the search is carried out from the top to the bottom of the range. Based on the directivity edge search, in the case where an edge point whose decrease in density is larger than a predetermined threshold value has been found, the edge point is detected as one of the boundary points (one of the points shown by x in FIG. 14). In the case where no such edge point has been found, it is judged that no boundary point exists on the scanning line. In other words, the number of the boundary points detected in the search along the scanning lines L₁ to L₃ ranges from 0 to 3.

When the boundary point detection means 261 has detected the boundary points, the number and positions of the detected boundary points are input to the pectoralis muscle line detection means 262, and the pectoralis muscle line t is detected. For example, in the case where the number of the detected boundary points is 3, a quadratic curve connecting the 3 boundary points is drawn and used as the pectoralis muscle line t. In the case where the number of the detected boundary points is 2, a line connecting the 2 points is drawn and used as the pectoralis muscle line t. In the case where the number of the detected boundary points is 1, a perpendicular line is drawn from the highest point in the breast in the image, and the lowermost point of the perpendicular line (the point at the lower end of the image) is found. The line connecting the point and the detected boundary point is then drawn and used as the pectoralis muscle line t (see FIG. 15). In the case where no boundary point has been detected, the pectoralis muscle line t is assumed to be not present.

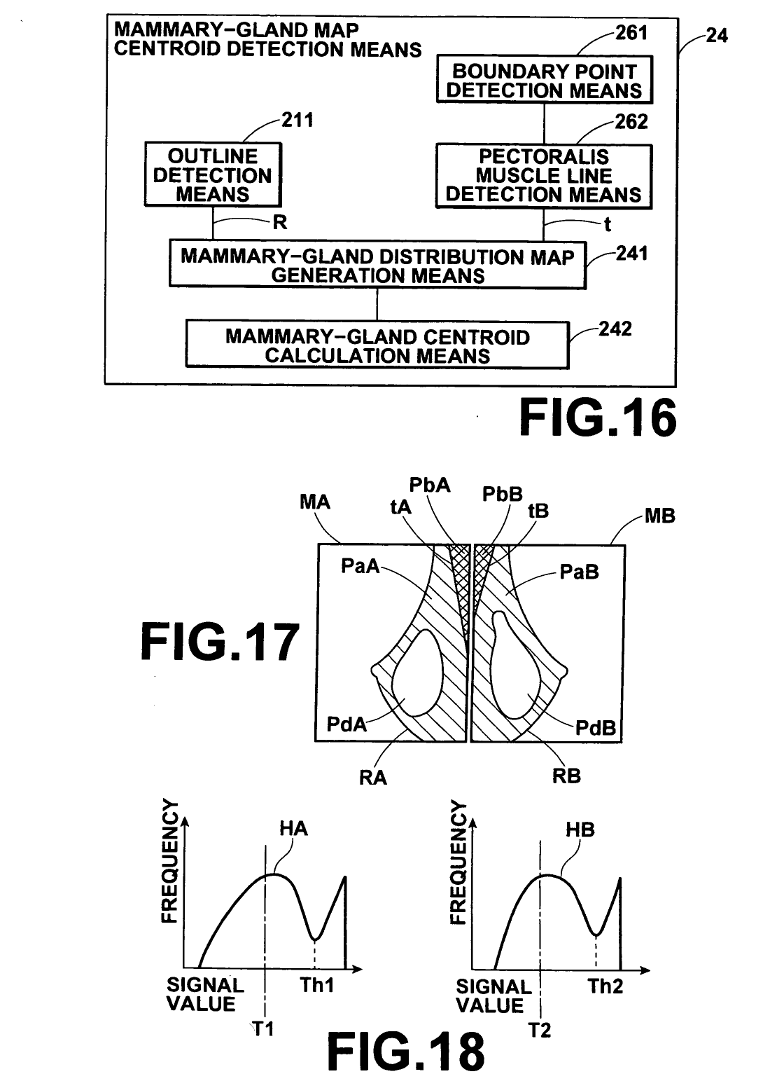

The mammary-gland map centroid detection means 24 comprises the boundary point detection means 261 for detecting the boundary points on the boundary line between the breast area and the pectoralis muscle area, the pectoralis muscle line detection means 262 for detecting the pectoralis muscle line t, the outline detection means 211 for detecting the skin line R, mammary-gland distribution map generation means 241 for generating a mammary gland map in each of the breasts in the corresponding breast area excluding the pectoralis muscle area surrounded by the pectoralis muscle line t and the skin line R, and mammary-gland centroid calculation means 242 for calculating the centroid of the mammary gland map, as shown in FIG. 16.

The subject in each of the breast images SA and SB is divided into areas according to density of the image signal, and mammary gland maps MA and MB shown in FIG. 17 are generated. As a method of generating the maps may be used a mammary gland distribution extraction method (see Tomoko Matsubara et al. “Method of Automatic Classification of Mammograms Based on Evaluation of Actual Density of Mammary Glands (in Japanese)” Bio Medical Engineering, Vol. 38, No. 2, June 2000). More specifically, as has been described for the boundary point detection means 261 and the pectoralis muscle line detection means 262, pectoralis muscle lines tA and tB are detected as the boundaries between the pectoralis muscles and the others, based on the density change in the images. The skin lines RA and RB are also detected in the same manner by the outline detection means 211. Areas surrounded by the skin lines RA and RB and the pectoralis muscle lines tA and tB are then found as breast areas PaA (including PdA) and PaB (including PdB). As shown in FIG. 18, in each of the histograms of pixel values not larger than the threshold values Th1 and Th2 in the breast area PaA including PdA and the breast area PaB including PdB, a lower density side corresponds to a mammary gland area and a higher density side corresponds to a fat area. Therefore, the breast areas PaA and PaB are binarized by reference values T1 and T2 as pixel values at the boundaries between the breast areas and the fat areas, and the mammary gland areas are the areas having the density values not higher than the reference values while the fat areas are the areas having the density values higher than the reference values. By carrying out this procedure, the mammary gland maps MA and MB are obtained wherein the pectoralis muscle areas PbA and PbB, the fat areas PaA (excluding PdB) and PaB (excluding PdB), and the mammary gland areas PdA and PdB are separated.

The mammary-gland centroid calculation means 242 calculates the centroids from the mammary gland areas PdA and PdB in the mammary gland maps MA and MB generated by the mammary-gland distribution map generation means 241.

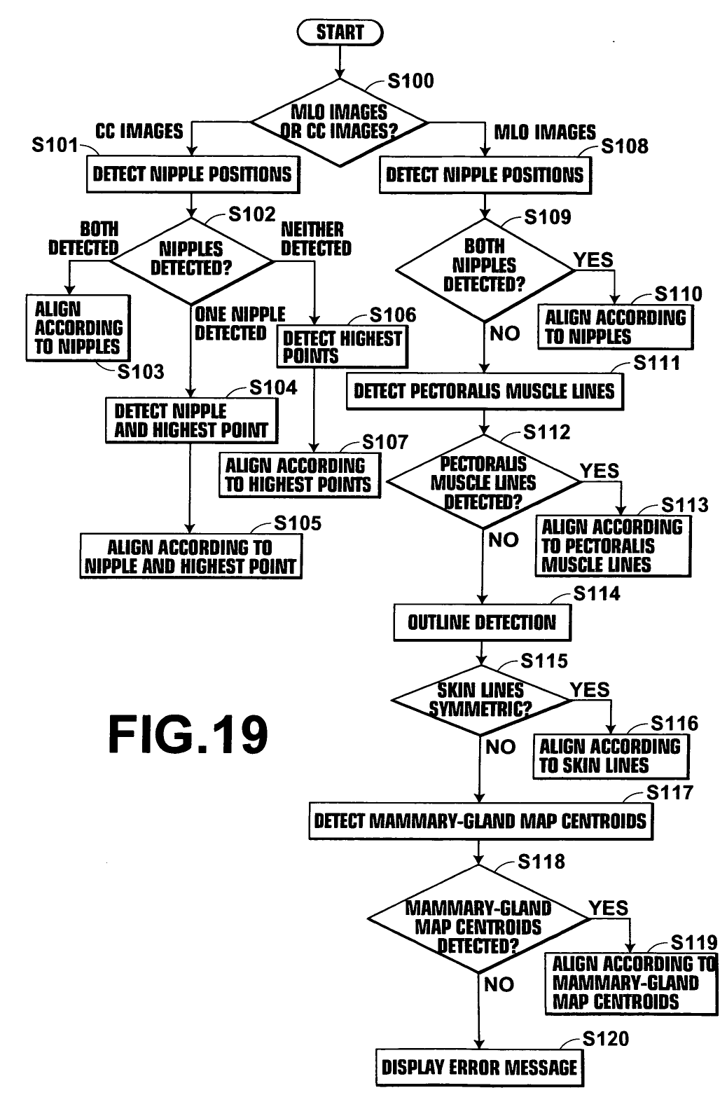

The alignment means 30 will be described next, with reference to the flow chart shown in FIG. 19.

The alignment means 30 judges whether the breast images SA and SB are MLO images or CC images (S100).

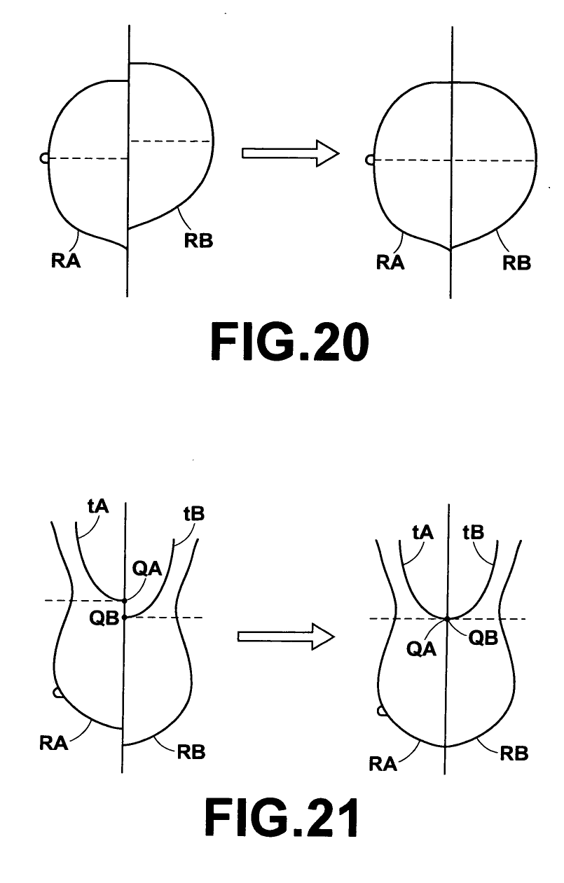

In the case where the breast images are CC images, the highest point in each of the breast areas substantially agrees with the nipple position therein. Therefore, the nipple position detection means 21 detects the nipple positions (S101). In the case where the nipples have been detected in the breast images SA and SB (S102), the alignment means 30 aligns the images so that the nipple positions used as the corresponding positions are positioned at the same height (S103). In the case where either one of the nipples has not been detected (S102), the nipple and highest point detection means 23 is used for detecting the highest point from the image from which the nipple has not been detected (S104). The nipple and the highest point are then used as the corresponding positions, and positioned at the same height as shown in FIG. 20 (S105).

In the case where the nipples have not been detected in the breast images SA and SB (S102), the highest-point position detection means 22 is used for detecting the highest points from the breast images (S106) to be used for the alignment (S107).

In the case where the breast images are MLO images, the highest points in the breast areas are not the nipples in many cases. Therefore, the alignment is carried out according to the pectoralis muscle lines, the skin lines, and the centroids in the mammary gland maps in the case where the nipples have not been detected.

The nipple position detection means 21 is used for detecting the nipple positions (S108). In the case where the nipples have been detected in the breast images SA and SB (S109), the nipple positions are used as the corresponding positions. Therefore, the images are aligned so that the nipple positions are at the same height (S110). In the case where the nipple has not been detected in either one of the breast images (S109), the pectoralis muscle line position detection means 26 detects the pectoralis muscle lines (S111). In the case where the pectoralis muscle lines have been detected in the breast images SA and SB (S112), the breast images are aligned in such a manner that a point QA at which the pectoralis muscle line intersects with the lower end of the breast image SA (see FIG. 15) agrees a point QB in the breast image SB corresponding to the point QA, as shown in FIG. 21 (S113).

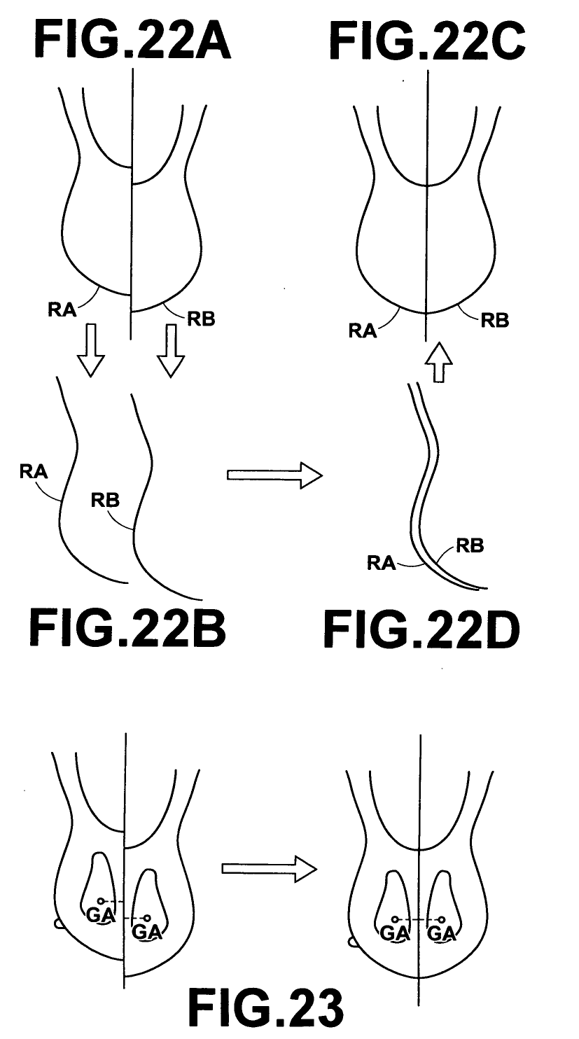

In the case where the pectoralis muscle lines t have not been detected in the breast images SA and SB (S112), the outline position detection means 25 detects the skin lines RA and RB (S114). In the case where the skin lines RA and RB are almost symmetric (S115), the breast images are aligned according to the skin lines (S116). For example, as shown in FIG. 22B, the skin line RB of the left breast image SB is flipped over, and the skin line RA and the flipped skin line RB are moved so as to cause a difference between the skin lines to be minimal as shown in FIG. 22D. The breast images are then aligned as shown in FIG. 22C. In the case where the difference between the skin lines is larger than a predetermined value after the movement, the skin lines RA and RB are judged to be asymmetric. Therefore, the alignment according to the skin lines is not carried out.

In the case where the alignment is not carried out by the skin lines RA and RB, the mammary-gland map centroid detection means 24 is used for the alignment (S117). In the case where the mammary gland maps have been detected clearly (S118), centroids GA and GB of the mammary gland maps are detected in the breast images SA and SB. The breast images are then aligned so as to cause the centroids to be located at the same height (S119). In the case where all the means fail to align the images, an error message is displayed (S120).

In the case where the corresponding positions have been detected in the above manner, the breast images SA and SB are aligned and displayed in a symmetric manner.

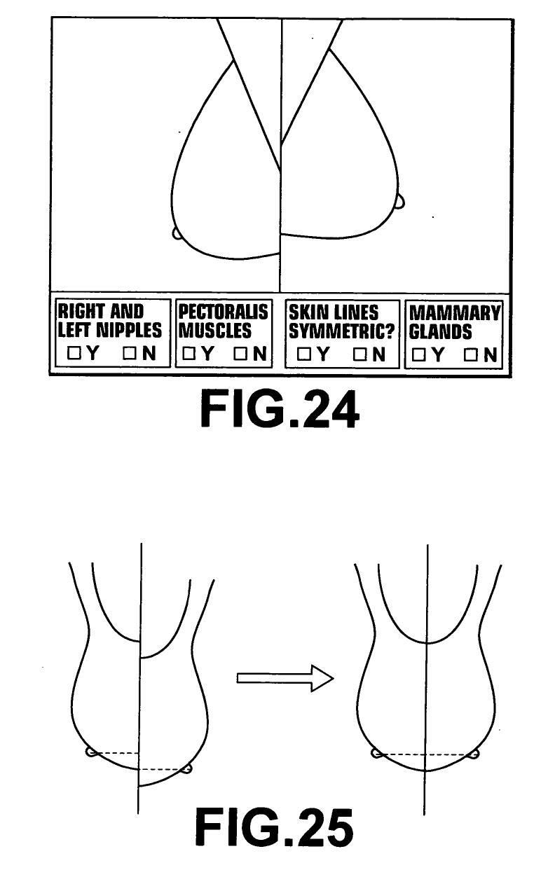

Before the alignment, the breast images SA and SB are displayed as shown in FIG. 24 for selection of any one of the corresponding position detection means. In this case, only one of the corresponding position detection means or more may be selected.

In the case where the breast images are MLO images, alignment by the highest points has not been described above. However, the alignment according to the highest points may be carried out by the highest-point position detection means 22 as shown in FIG. 25 or by the nipple and highest point detection means 23.

In this embodiment, presence or absence of nipples is judged based on success or failure of detection of the corresponding positions. However, in the case where information on presence or absence of the nipples can be obtained from patient information or the like in an electronic chart or attached to the images, the information may be used.

As has been described above, the plurality of corresponding position detection means allows more accurate alignment and lead to less failure of alignment.

What is claimed is:

1. A breast image display apparatus for displaying a right breast image and a left breast image in alignment with respect to each other, the image display apparatus comprising:
breast area detection means for detecting a right breast area representing a right breast and a left breast area representing a left breast in the right breast image and the left breast image;
a plurality of corresponding position detection means for respectively detecting different preset corresponding positions in the right breast area and the left breast area that have been detected; and
alignment means for causing one of the corresponding position detection means to detect the corresponding positions therefor in the right breast area and in the left breast area and for carrying out the alignment between the right breast image and the left breast image based on the detected positions in the case where the corresponding positions have been detected, or else for causing another one of the corresponding position detection means to detect the corresponding positions therefor and for carrying out the alignment between the right breast image and the left breast image based on the detected positions.

2. The breast image display apparatus according to claim 1, wherein the plurality of corresponding position detection means include at least two of:
nipple position detection means for detecting positions of nipples as the corresponding positions in the right breast area and in the left breast area;
highest-point position detection means for detecting highest points as the corresponding positions in the right breast area and in the left breast area;
nipple and highest point detection means for detecting a position of a nipple in either the right breast area or the left breast area and a highest point in the other breast area, as the corresponding positions;
mammary-gland map centroid detection means for detecting centroids of mammary gland maps as the corresponding positions in the right breast area and in the left breast area;
outline position detection means for detecting outlines of the right breast area and the left breast area whose positions are used as the corresponding positions; and
pectoralis muscle line position detection means for detecting pectoralis muscle lines whose positions are used as the corresponding positions in the right breast area and the left breast area.

3. A program causing a computer in a breast image display apparatus for displaying a right breast image and a left breast image in alignment with respect to each other to function as:
breast area detection means for detecting a right breast area representing a right breast and a left breast area representing a left breast in the right breast image and the left breast image;
a plurality of corresponding position detection means for respectively detecting different preset corresponding positions in the right breast area and the left breast area; and
alignment means for causing one of the corresponding position detection means to detect the corresponding positions therefor in the right breast area and in the left breast area and for carrying out the alignment between the right breast image and the left breast image based on the detected positions in the case where the corresponding positions have been detected, or else for causing another one of the corresponding position detection means to detect the corresponding positions therefor and for carrying out the alignment between the right breast image and the left breast image based on the detected positions.
